(19) United States
(12) Patent Application Publication
(10) Pub. No.: US 2021/0298133 A1
(43) Pub. Date: Sep. 23, 2021

(54) HEATING DEVICE AND CONTROL METHOD OF HEATING DEVICE

(71) Applicant: HONDA MOTOR CO., LTD., Tokyo (JP)

(72) Inventor: Masahiko TASHIRO, Wako-shi (JP)

(21) Appl. No.: 17/204,118

(22) Filed: Mar. 17, 2021

(30) Foreign Application Priority Data
Mar. 19, 2020 (JP) 2020-048883

(51) Int. Cl. H05B 6/06; H05B 6/10

(52) U.S. Cl. CPC H05B 6/06; H05B 6/10

(57) ABSTRACT

A heat generator includes: a high-frequency power source configured to generate a high-frequency power with a variable frequency; a heating element connected to the high-frequency power source; and a controller configured to set the high-frequency power to a frequency such that the high-frequency power with the frequency maximizes a quotient obtained by dividing a measured temperature change of the heating element by a temperature change of the heating element when the heating element is supplied with a DC power equal to the high-frequency power supplied to the heating element, the controller being configured to drive the high-frequency power source to generate the high-frequency power having approximately the frequency. The heating element may include a resistor, and the quotient may be maximized at the frequency of 2 to 30 MHz.

### CROSS-REFERENCE TO RELATED APPLICATIONS

The present application claims priority under 35 U.S.C. §119 to Japanese Patent Application No. 2020-048883, filed on Mar. 19, 2020, the contents of which are hereby incorporated by reference in their entirety.

### BACKGROUND OF THE INVENTION

### 1. Field of the Invention

The invention relates to a heat generator and a method of controlling the heat generator and, for example, relates to a heat generator that causes a resistor to generate heat with high-frequency power.

### 2. Description of the Related Art

Many heat generators including heating wires are used as apparatuses for heating and melting materials or stoves. For example, Japanese Patent Laid-open Publication No. 4-337272 (Patent Literature 1) discloses a switching control-type heat generating circuit which generates a consistent amount of heat through switching control.

According to the technique of Patent Literature 1, the frequency of rectangular waves applied to a heating wire is fixed, and this restricts optimization of the amount of heat generated by the heating wire (a heating element).

### SUMMARY OF THE INVENTION

The invention has been made to solve the above problems and makes it an object thereof to provide a heat generator which is able to generate a greater amount of heat through a heating element and the method of controlling the heat generator.

To achieve the aforementioned object, a heat generator of the aspect includes: a high-frequency power source configured to generate a high-frequency power with a variable frequency (1); a heating element (a resistor 4) connected to the high-frequency power source; and a controller (50) configured to set the high-frequency power to a frequency such that the high-frequency power with the frequency maximizes a quotient obtained by dividing a measured temperature change of the heating element by a temperature change of the heating element when the heating element is supplied with a DC power equal to the high-frequency power supplied to the heating element, the controller being configured to drive the high-frequency power source to generate the high-frequency power having approximately the frequency. The numerals and characters in the brackets are those given in embodiments described later and will not limit the present invention.

According to the aspect, it is possible to increase the amount of heat generated by the heating element.

### BRIEF DESCRIPTION OF THE DRAWINGS

FIG. 1 is a configuration diagram of a heat generator according to a first embodiment of the invention.

FIG. 2 is a voltage vector diagram of an RLC series circuit.

FIG. 3 is a configuration diagram of a heat generator according to a second embodiment of the invention.

FIG. 4 is a diagram illustrating frequency characteristics of voltage across a resistor.

FIG. 5 is a diagram illustrating frequency characteristics of current flowing through the resistor.

FIG. 6 is a diagram illustrating the relationship between DC power supply and temperature change of the resistor.

FIG. 7 illustrates frequency characteristics of temperature change of the resistor.

FIG. 8 is a diagram illustrating the ratio of measured temperature change of the resistor to predicted temperature change.

FIG. 9 is a diagram illustrating the relationship between temperature change of the resistor and the resistance.

FIG. 10 is a diagram illustrating frequency characteristics of voltage across a resistor.

FIG. 11 is a diagram illustrating frequency characteristics of current flowing through the resistor.

FIG. 12 is a diagram illustrating the relationship between DC power supply and temperature change of the resistor.

FIG. 13 illustrates frequency characteristics of temperature change of the resistor.

FIG. 14 is a diagram illustrating the ratio of measured temperature change of the resistor to predicted temperature change.

FIG. 15 is a diagram illustrating the relationship between temperature change of the resistor and the resistance.

FIG. 16 is a diagram illustrating frequency characteristics of measured effective voltage of an R circuit.

FIG. 17 is a diagram illustrating frequency characteristics of measured effective current of the R circuit.

FIG. 18 is a diagram illustrating frequency characteristics of temperature change of the resistor.

FIG. 19 is a diagram illustrating frequency characteristics of a value obtained by dividing measured temperature change of the R circuit by predicted temperature change.

FIG. 20 illustrates frequency characteristics of voltage across a fixed capacitor.

FIG. 21 illustrates frequency characteristics of current flowing through the fixed capacitor.

FIG. 22 illustrates frequency characteristics of the current ratio obtained by dividing measured current by calculated current.

FIG. 23 is a diagram illustrating frequency characteristics of a current probe.

FIG. 24 is a diagram illustrating frequency characteristics of a typical resistor.

FIG. 25 is a flowchart for explaining the operation of a controller.

### DETAILED DESCRIPTION OF THE EMBODIMENTS

Embodiments of the invention (hereinafter just referred to as the embodiments) will be hereinafter described in detail with reference to the accompanying drawings. The drawings provide schematic illustrations just enough to give sufficient understanding of the embodiments. The same or similar constituent components across the drawings are given the same reference numerals, and overlapping description thereof will be omitted.

### First Embodiment

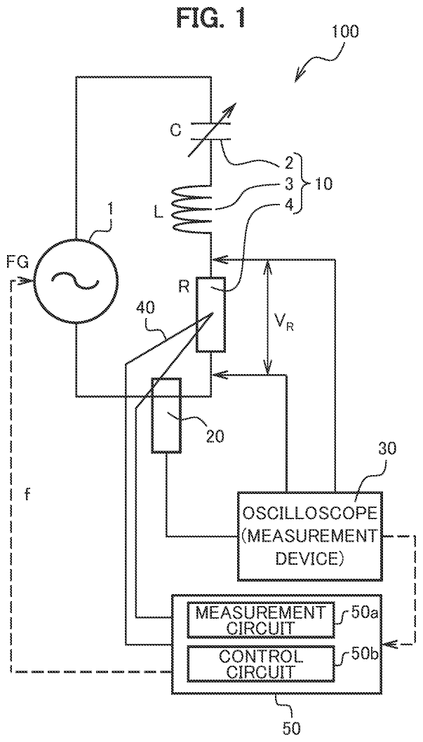

FIG. 1 is a configuration diagram of a heat generator 100 according to a first embodiment of the invention.

The heat generator 100 includes a function generator 1 as a high-frequency power source, an RLC series circuit 10, an oscilloscope 30 as a measurement device, a current probe 20, a thermocouple 40, and a controller 50. The RLC series circuit 10 is a series circuit including a variable capacitor 2, a coil 3, and a resistor 4 as a heating element.

The function generator 1 is able to generate arbitrary waveforms at any frequency. In this embodiment, the function generator 1 is used as a sine-wave generator that is able to change the frequency with signal f. Herein, the function generator 1 is assumed to generate sine-waves with frequencies of about 2 to 30 MHz.

The function generator 1 is YOKOGAWA FG410, for example. The amplitude frequency characteristic of sine waves is ±0.3 dB for 5 to 20 MHz and ±0.5 dB for 20 to 30 MHz. In the function generator 1, waveforms are generated by a direct digital synthesizer and are then outputted as analog signals through a D/A converter and a low-pass filter. The function generator 1 does not include any resonance circuit.

The variable capacitor 2 is a capacitor whose capacitance C is variable. The coil 3 is a coil having an inductance L. The coil 3 is made of enameled wire with a diameter of 0.55 (mm) and has a shape with an inner diameter of 14 mm and a height of 10 mm, for example. The resistor 4 is a thick film-type resistor. The variable capacitor 2, the coil 3, and the resistor 4 are connected in series to constitute the RLC series circuit 10. The RLC series circuit 10 is supplied with sine-wave high-frequency voltage from the function generator 1. The RLC series circuit 10 is resonated for use by adjusting the capacitance C of the variable capacitor 2.

The oscilloscope 30 is a measurement device for observing voltage waveforms of plural channels and is used to measure voltage at any channel. The oscilloscope 30 has a voltage probe connected to both ends of the resistor 4 and measures voltage V_{R} across the resistor 4. The oscilloscope 30 is YOKOGAWA DLM2034, for example. The frequency bandwidth (≥−3 dB) of this oscilloscope 30 is 250 MHz for 100 mV/div to 100 V/div and 300 MHz for 20 to 50 mV/div (for an input of a sine-wave of amplitude ±3 div). These frequency bandwidths are sufficiently wider than the frequency range of 2 to 30 MHz of sinewaves outputted from the function generator 1.

The current probe 20 connects to another channel of the oscilloscope 30 and measures current flowing through the RLC series circuit 10. The current probe 20 measures the current by clamping a conductor and does not produce errors due to resistive voltage division. The current probe 20 is YOKOGAWA 701918, for example. The rated bandwidth of the current probe 20 is 120 MHz (−3 dB). The thermocouple 40 measures the temperature (surface temperature) of the resistor 4, and the measured temperature is inputted to the controller 50.

The controller 50 includes a measurement circuit 50a and a control circuit 50b.

The measurement circuit 50a is a functioning unit which incorporates temperature information acquired by the thermocouple 40. The control circuit 50b is a central processing unit (CPU) and is a functioning unit controlling the oscilloscope 30 and the function generator 1. The control circuit 50b controls the oscillation frequency of the function generator 1 so as to maximize the ratio of the amount of heat generated by the resistor 4 to high-frequency power supplied to the resistor 4. The temperature change (temperature rise) of the resistor 4 is proportional to the amount of heat generated by the resistor 4. The control circuit 50b therefore controls the oscillation frequency of the function generator 1 so as to maximize the ratio of the surface temperature of the resistor 4 to the high-frequency power supplied to the resistor 4.

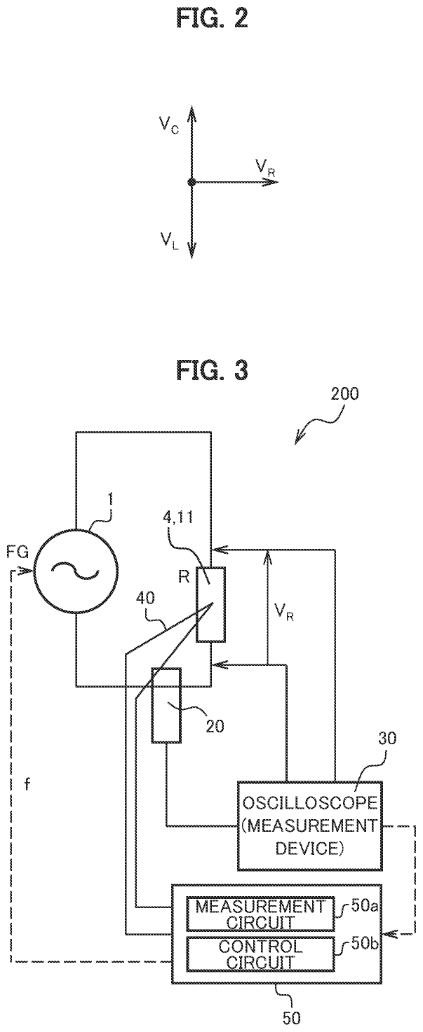

FIG. 2 is an AC voltage vector diagram of an RLC circuit.

The RLC series circuit 10 (FIG. 1) is a series circuit composed of the variable capacitor 2, the coil 3, and the resistor 4. The voltage V_{c} across the variable capacitor 2 is in antiphase to voltage V_{L} across the coil 3. The voltage V_{R} across the resistor 4 is phase-shifted by 90 degrees from the voltages V_{c} and V_{L}. The capacitance C of the variable capacitor 2 is adjusted for resonance, so that |V^{c}|=|V_{L}|. The impedance Z of the RLC series circuit 10 thus equals to R. In other words, the RLC series circuit 10 may be a circuit without the variable capacitor 2 and the coil 3. Lead wire (diameter: about 0.7 mm) used for wiring has an inductance 1 per unit length of about 10⁻⁶ H/m.

The reactance thereof, which is about 60 Wm at 10 MHz, is negligible due to resonance.

As described later, we have found that the amount of heat (temperature change) generated by the resistor 4 when the resistor 4 is supplied with high-frequency power of a specific range of frequencies (for example, 2 to 30 MHz, and preferably, 4 to 26 MHz) is greater than the amount of heat (temperature change) generated by the resistor 4 when the resistor 4 is supplied with a DC power equal to the high-frequency power. The heat generator 100 of the embodiment utilizes this finding.

### Second Embodiment

First, the configuration of a second embodiment will be described, and then the characteristics thereof will be evaluated compared with the first embodiment.

FIG. 3 is a configuration diagram of a heat generator 200 according to the second embodiment of the invention.

The heat generator 200 includes the function generator 1 as the sine-wave generator, the resistor 4, the oscilloscope 30 as the measurement device, the current probe 20, the thermocouple 40, and the controller 50. The second embodiment is characterized in that the function generator 1 only connects to the resistor 4. The circuit including only the resistor 4 is also referred to as an R circuit 11.

### (Characteristic Evaluation)

The followings will describe about electrical characteristics and temperature change characteristics of the heat generator 100 of the first embodiment and the heat generator 200 of the second embodiment.

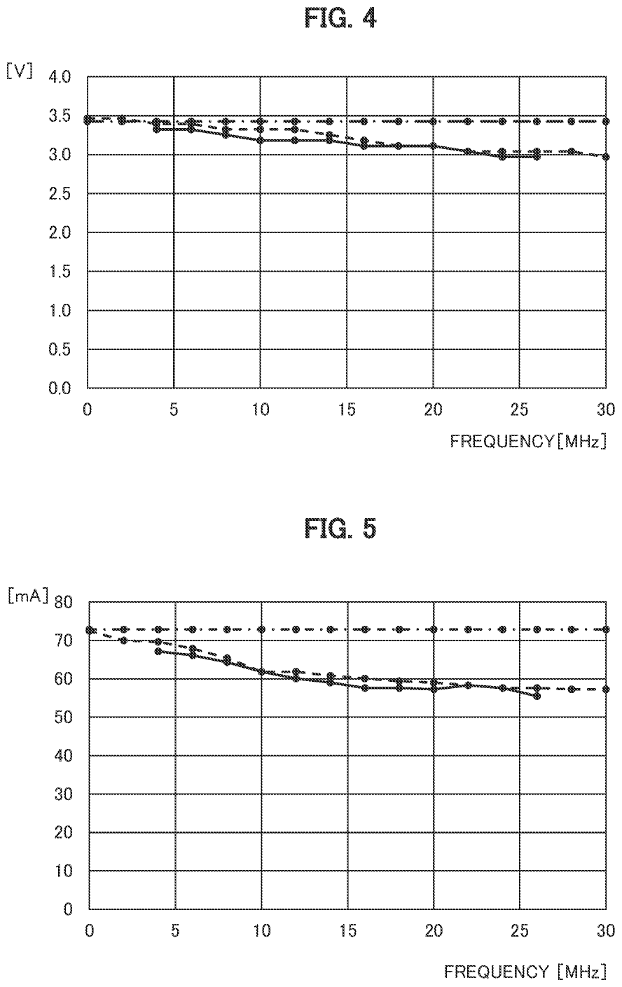

FIG. 4 is a diagram illustrating frequency characteristics of voltage across the resistor 4. FIG. 5 is a diagram illustrating frequency characteristics of current through the resistor 4.

The horizontal axes in FIGS. 4 and 5 are frequency (MHz) of the function generator 1, measuring from 2 to 30 MHz. The vertical axis of FIG. 4 is effective voltage (V) across the resistor 4. The solid line indicates measured effective voltage of the resistor 4 of the RLC series circuit 10, and the broken line indicates measured effective voltage of the R circuit 11. The dashed-dotted line indicates calculated effective voltage of the RLC series circuit 10 and R circuit 11. The vertical axis of FIG. 5 is effective current (mA) through the resistor 4. The solid line indicates measured effective current through the resistor 4 of the RLC series circuit 10, and the broken line indicates measured effective current through the R circuit 11. The dashed-dotted line indicates calculated effective current of the RLC series circuit 10 and R circuit 11.

The calculated effective voltage and current of the

RLC series circuit 10 and R circuit 11 are acquired as follows. Herein, the output voltage setting of the function generator 1 is 20 Vp-p (the effective voltage is 7.07 V), and the output impedance is 50 Ω. The calculated effective voltage is 7.07 V×{47 Ω(47 Ω+50 Ω)}=3.426 V. The calculated effective current is 3.426 V/47 Ω=72.9 mA.

The measured effective voltage and measured effective current of the RLC series circuit 10 and R circuit 11 gradually decrease with frequency. In particular, the measured effective current (FIG. 5) decreases with a gradient about twice that of the measured effective voltage (FIG. 4). The difference between the RLC series circuit 10 and R circuit 11 is very small.

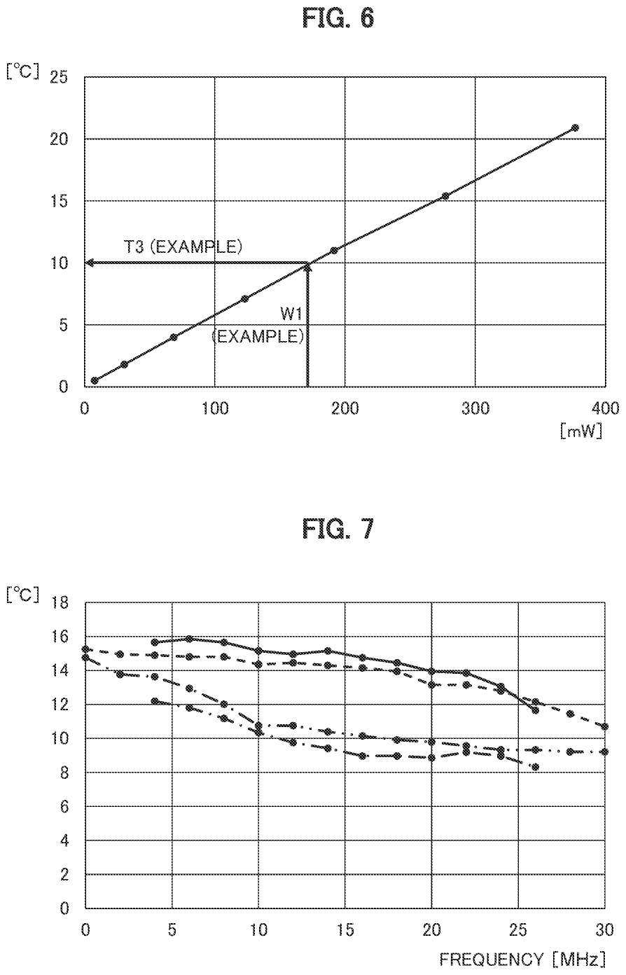

FIG. 6 is a diagram illustrating the relationship between DC power supply and temperature change of the resistor 4.

The horizontal axis of FIG. 6 is DC power (mW) calculated by multiplying the square of direct current through the resistor 4 by the resistance (47 Ω). For example, if 72.9 mA direct current flows through the resistor 4 having a resistance of 47 Ω), the DC power is calculated to be 250 mW. The vertical axis is change (° C.) in surface temperature (temperature change) measured by the thermocouple 40 when direct current flows through the resistor 4. Temperature change T1 is T2−T0 where T2 is measured temperature of the resistor 4 and T0 is measured ambient temperature. For example, temperature change T3 is 10° C. when W1 is 174 mW, and the gradient of temperature change is therefore 0.0575° C./mW.

FIG. 7 illustrates frequency characteristics of temperature change of the resistor 4.

The horizontal axis of FIG. 7 is frequency (MHz) of the function generator 1, measuring from 2 to 30 MHz. The vertical axis is change (° C.) in surface temperature (temperature change) of the resistor 4 measured by the thermocouple 40. The solid line indicates measured temperature change of the RLC series circuit 10 (FIG. 1), and the broken line indicates measured temperature change of the R circuit 11 (FIG. 3). The dashed-dotted line indicates predicted temperature change of the RLC series circuit 10, and the dashed-two dotted line indicates predicted temperature change of the R circuit 11.

In the RLC series circuit 10 and R circuit 11, the predicted temperature change refers to change (FIG. 6) in surface temperature (surface temperature with direct current) of the resistor 4 measured when the resistor 4 is supplied with a DC power (mW) equal to a high-frequency power (resistance (47 Ω)×effective (FIG. 5)²) supplied to the resistor 4. Even if the resistor 4 is supplied with a DC power equal to a high-frequency power (apparent power; effective voltage (FIG. 4)×effective current (FIG. 5)), the temperature change shows the same tendency as that in FIG. 6.

Both the measured temperature change and predicted temperature change gradually decrease with frequency. The temperature change is thus characterized in that the measured temperature change (solid and broken lines) is greater than the predicted temperature change (dashed-dotted and dashed-two dotted lines). In other words, the temperature change (temperature rise) due to high frequency power is greater than the temperature change (temperature rise) due to DC power.

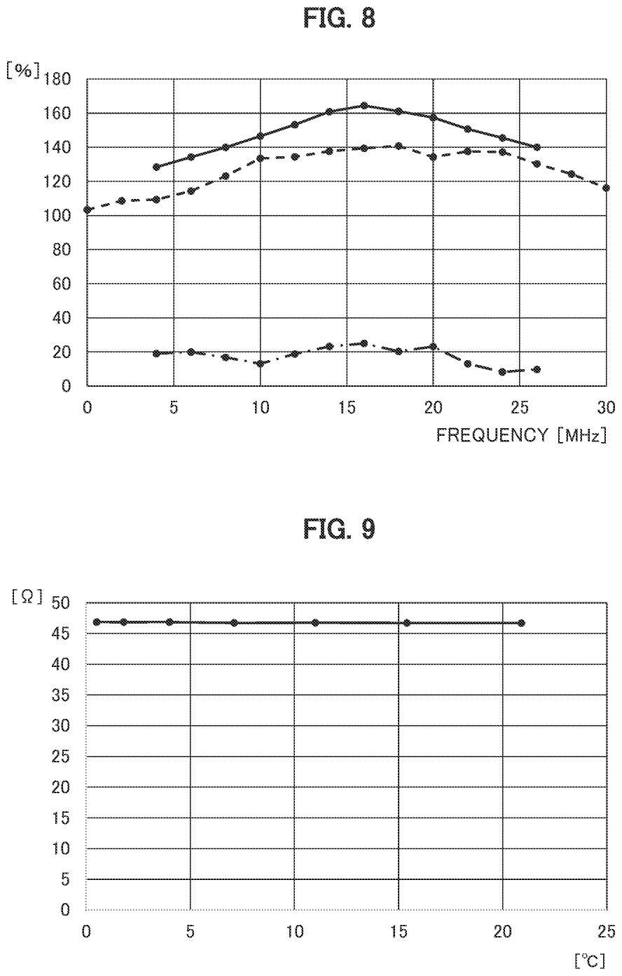

FIG. 8 is a diagram illustrating the ratio of measured temperature change of the resistor 4 to predicted temperature change.

The horizontal axis in FIG. 8 is frequency (MHz) of the function generator 1, measuring from 2 to 30 MHz. The horizontal axis is the value (%, ratio) obtained by dividing measured temperature change of the resistor 4 by predicted temperature change. The solid line indicates the ratio of the RLC series circuit 10, and the broken line indicates the ratio of the R circuit 11. The dashed-dotted line indicates the difference in ratio between the RLC series circuit 10 and R circuit 11 (the ratio of the RLC series circuit 10−the ratio of the R circuit 11).

Since the measured temperature change is greater than the predicted temperature change (FIG. 7), the ratio in temperature change of the RLC series circuit 10 and R circuit 11 is higher than 100% in a frequency range from 2 to 30 MHz. As for the RLC series circuit 10, for example, the ratio in temperature change reaches a peak of 161% at 16 MHz. Thus, we have found that the temperature change of the resistor 4 when the resistor 4 is supplied with high-frequency power with a specific frequency range (4 to 26 MHz) is greater than the temperature change of the resistor 4 when the resistor 4 is supplied with a DC power equal to the high-frequency power.

The ratio of the RLC circuit 10 (solid line) is greater than the ratio of the R circuit 11 (broken line), and the difference therebetween (dashed-dotted line) is 10 to 20%. In other words, the series circuit of the variable capacitor 2 and the coil 3 substantially affects the amount of heat generated by the resistor 4 by 10 to 20%.

FIG. 9 is a diagram illustrating the relationship between temperature change of the resistor 4 and the resistance thereof. The horizontal axis is temperature change (° C.) of the resistor 4 when direct current is applied to the resistor 4, and the vertical axis is resistance (Ω). The resistance is fixed at about 47 Ω even if the temperature changes.

Next, the same measurements as those described above are performed with the resistance R of the resistor 4 increased to 120 Ω from 47 Ω. The other measurement conditions are the same as those in FIGS. 4 to 9.

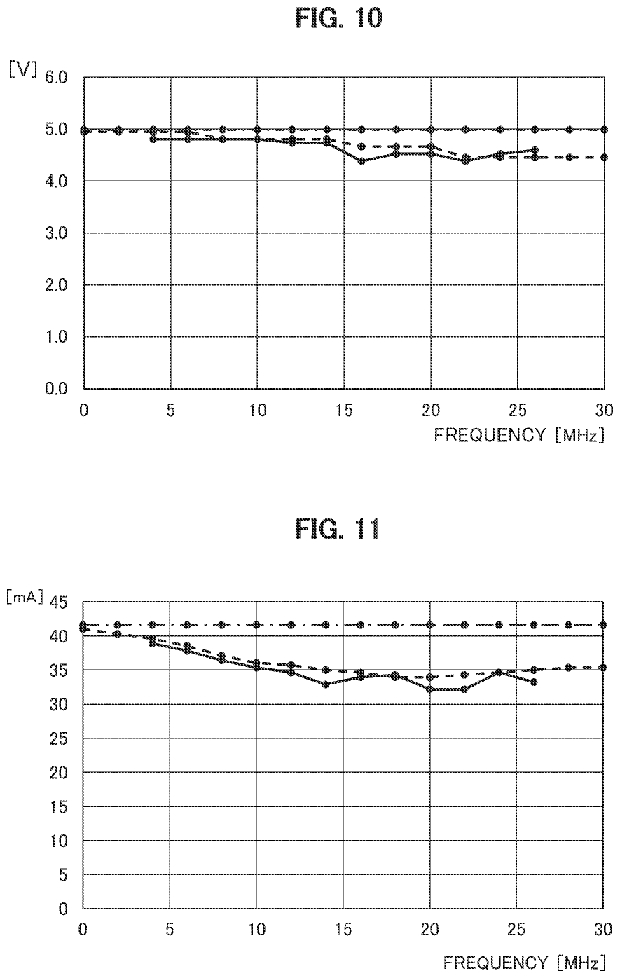

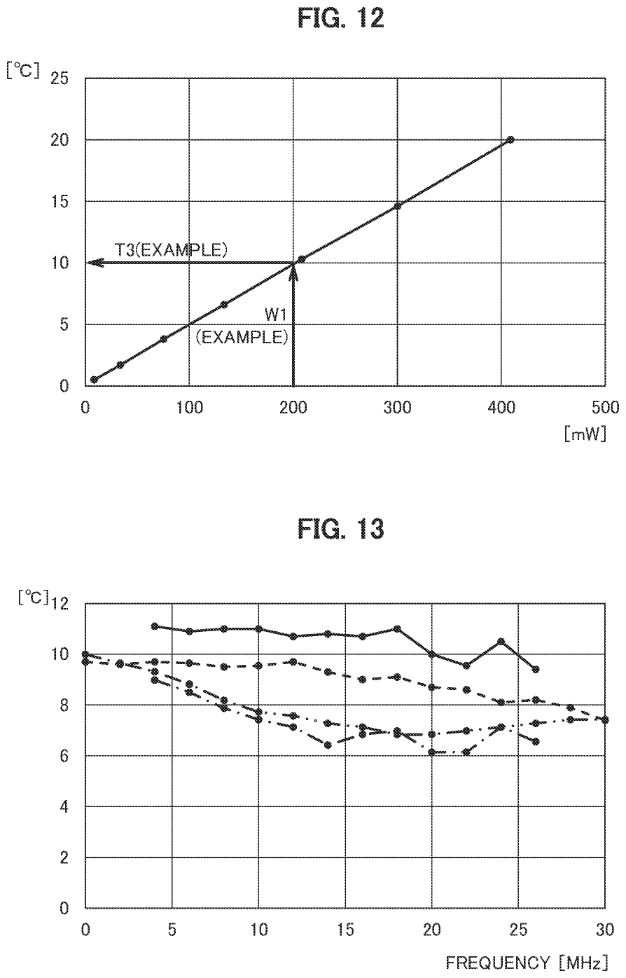

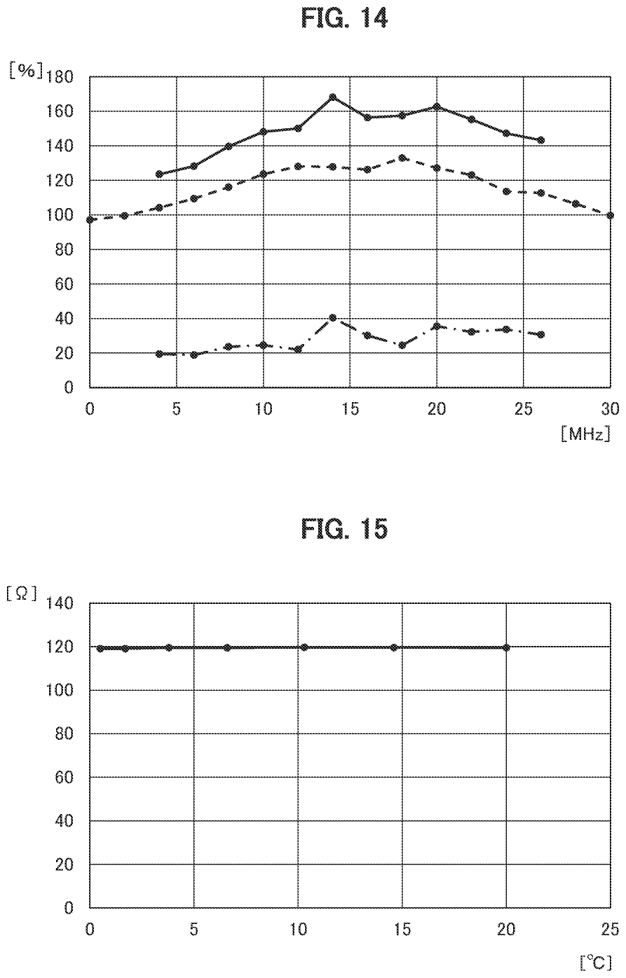

FIG. 10 is a diagram illustrating frequency characteristics of voltage across the resistor 4. FIG. 11 is a diagram illustrating frequency characteristics of current flowing through the resistor 4. FIG. 12 is a diagram illustrating the relationship between DC supply power and temperature change of the resistor 4. FIG. 13 illustrates frequency characteristics of temperature change of the resistor 4. FIG. 14 is a diagram illustrating the ratio of measured temperature change of the resistor 4 to predicted temperature change. FIG. 15 is a diagram illustrating the relationship between temperature change of the resistor 4 and the resistance thereof.

The calculated effective voltage and calculated effective current are acquired as follows. The effective output volage of the function generator 1 is 7.07 V, and the output impedance is 50 Ω. The calculated effective voltage is 7.07 V×{120 Ω(120 Ω)+50 Ω)}=4.99 V. The calculated effective current is 4.99 V/120 Ω=41.6 mA. The DC power corresponding to these calculated effective voltage and effective current is 207.5 mW.

Increasing the resistance R of the resistor 4 from 47 Ω to 120 Ω does not cause any change in the tendency. The temperature change in FIG. 14 is less than the temperature change in FIG. 7 since the DC power of 207.5 mW is less than the DC power of 250 mW supplied when the resistance is 47 Ω. In FIG. 14, the ratio in temperature change of the RLC series circuit 10 (solid line) reaches a peak of 171% at 14 MHz.

These results show that the amount of heat generated by the resistor 4 when the resistor 4 is supplied with high-frequency power of 4 to 30 MHz (preferably 10 to 20 MHz, and more preferably 13 to 17 MHz) is greater than that generated by the resistor 4 when the resistor 4 is supplied with a DC power corresponding to the high-frequency power.

Next, the effective voltage, effective current, temperature change of the resistor 4, and (measured temperature change/predicted temperature change) of the R circuit 11 are evaluated on a logarithmic frequency scale in the horizontal axis. The R circuit 11 is composed of only the resistor 4 having a resistance of 47 Ω.

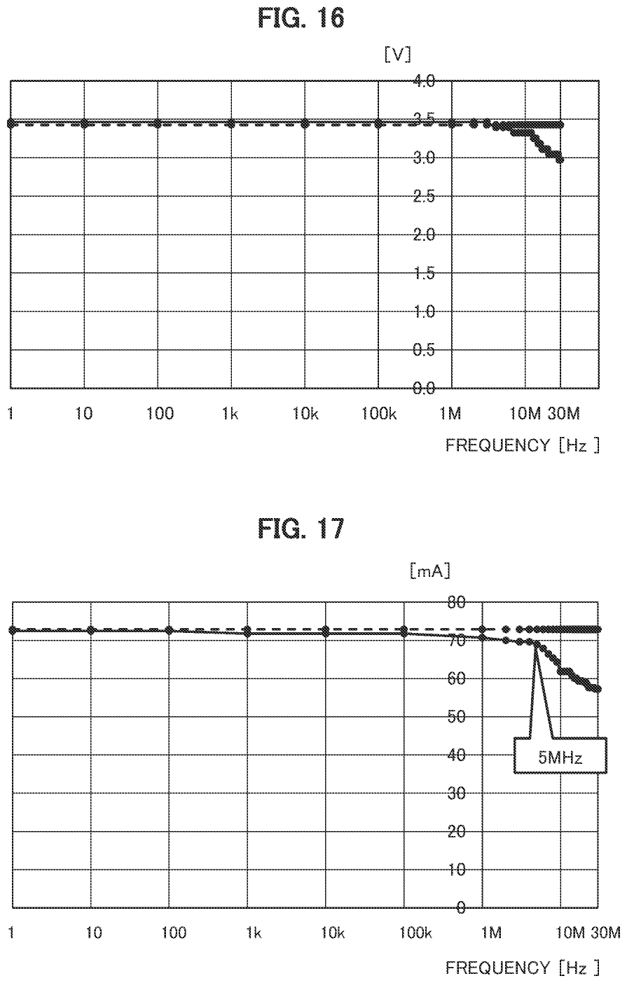

FIG. 16 is a diagram illustrating frequency characteristics of measured effective voltage of the R circuit 11. FIG. 17 is a diagram illustrating frequency characteristics of measured effective current of the R circuit 11. In FIGS. 16 and 17, the horizontal axes are frequency (Hz). The vertical axis in FIG. 16 is effective voltage (V), and the vertical axis in FIG. 17 is effective current (mA). In FIGS. 16 and 17, solid lines indicate measured values, and broken lines indicate calculated values.

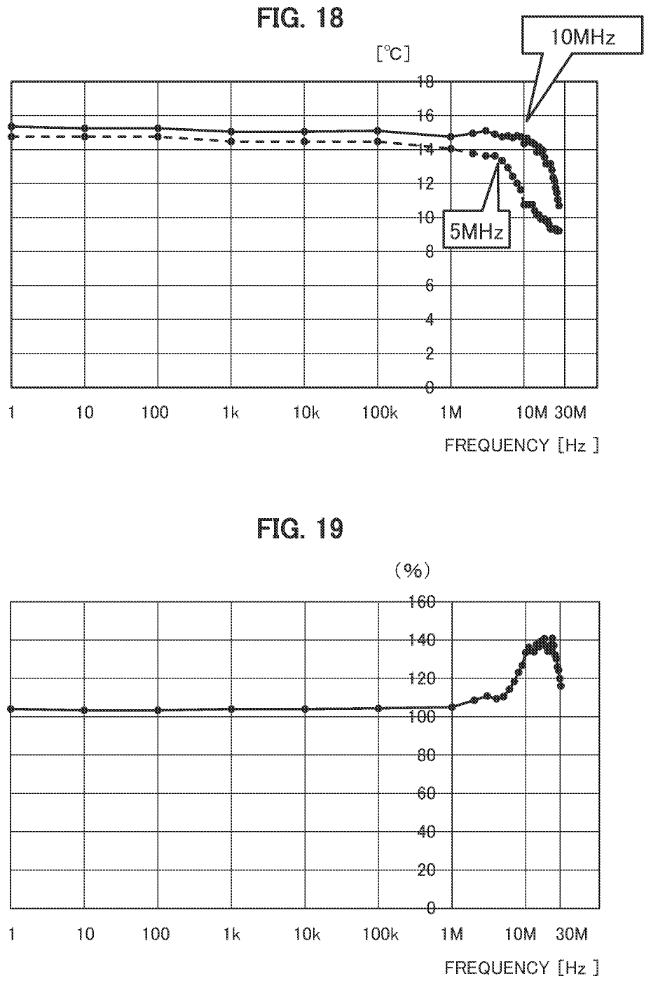

FIG. 18 is a diagram illustrating frequency characteristics of temperature change of the resistor 4. The horizontal axis is frequency (Hz), and the vertical axis is temperature (° C.). The solid line indicates measured temperature change, and the broken line indicates predicted temperature change. The predicted temperature change refers to an increase in temperature of the resistor 4 when the resistor 4 is supplied with a DC power corresponding to an AC power calculated by resistance×(effective current)².

The effective voltage (FIG. 16) starts linearly decreasing with frequency at around 10 MHz while the effective current (FIG. 17) starts decreasing gradually at around 5 MHz. On the other hand, the predicted temperature change (FIG. 18) starts decreasing linearly with frequency at around 5 MHz while the measured temperature change starts decreasing rapidly at around 10 MHz. In other words, the measured effective current (FIG. 17) starts decreasing gradually and linearly with frequency at around 5 MHz while the measured temperature change (FIG. 18) starts decreasing rapidly at around 10 MHz.

FIG. 19 is a diagram illustrating frequency characteristics of the ratio of measured temperature change of the R circuit 11 to predicted temperature change. The horizontal axis is frequency (Hz), and the vertical axis is the ratio (%). The measured temperature change/predicted temperature change reaches a peak in a frequency range from 5 to 30 MHz. In other words, the amount of heat generated with high-frequency power is greater than that generated with a DC power in a frequency range from 5 to 30 MHz. This phenomenon is due to increased kinetic energy of electrons. The kinetic energy of electrons is converted into thermal energy through collision of free electrons of current and electrons of atoms of the resistor 4.

(C circuit)

Next, frequency characteristics of a C circuit are measured. In the C circuit, sine-wave voltage of varying frequency is applied to a fixed capacitor having a capacitance of 5 pF, and sine-wave current is measured. The fixed capacitor does not generate heat, but it is important to determine whether the measured current changes in a specific range of frequencies (5 to 30 MHz, for example).

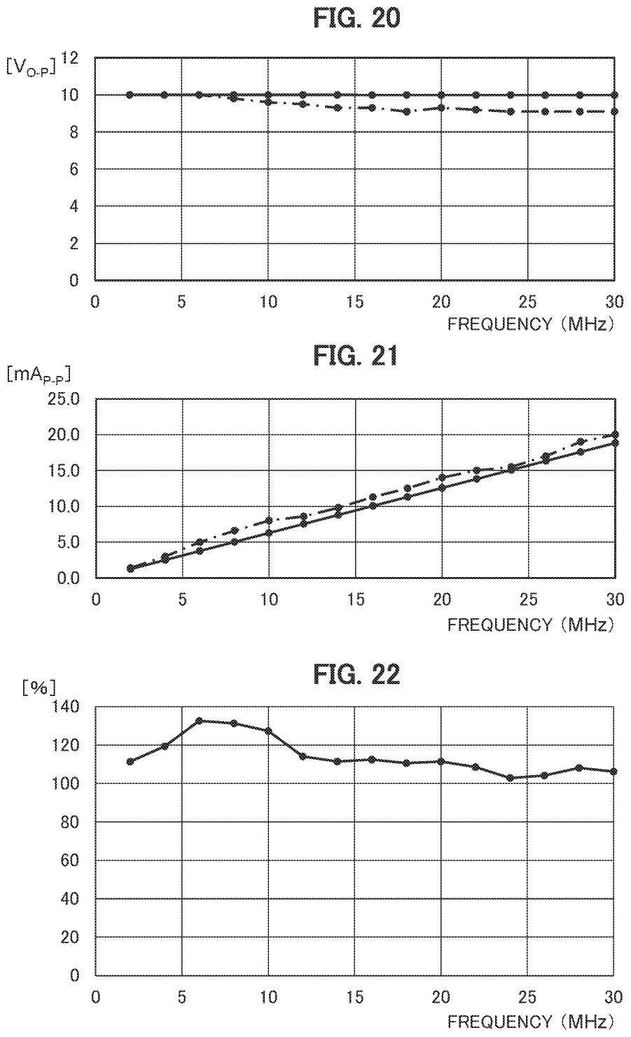

FIG. 20 illustrates frequency characteristics of voltage across the fixed capacitor. The horizontal axis is frequency (MHz), and the vertical axis is voltage (V₀₋ₚ). The solid line indicates calculated no-load voltage with the fixed capacitor being unconnected. The dashed-dotted line indicates measured voltage with the fixed capacitor being connected. The measured voltage is lower than the calculated voltage.

FIG. 21 illustrates frequency characteristics of current flowing through the fixed capacitor. The horizontal axis is frequency (MHz), and the vertical axis is current (mAₚ₋ₚ). The solid line indicates current calculated by I=ωCV, and the dashed-dotted line indicates measured current. The measured current is greater than the calculated current.

FIG. 22 illustrates frequency characteristics of the ratio of measured current to calculated current. The horizontal axis is frequency (MHz), and the vertical axis is the ratio of measured current to calculated current. The ratio exceeds 100% at frequencies of 2 to 30 MHz. This phenomenon is thought to be because the kinetic energy of electrons increased in the negative electrode of the fixed capacitor forces out free electrons in the positive electrode of the fixed capacitor to increase the current. At frequencies other than 2 to 30 MHz, the kinetic energy of electrons does not increase, and the current therefore does not increase.

Herein, the influence of the frequency characteristics of the current probe 20 (FIG. 1) and the resistor 4 will be examined.

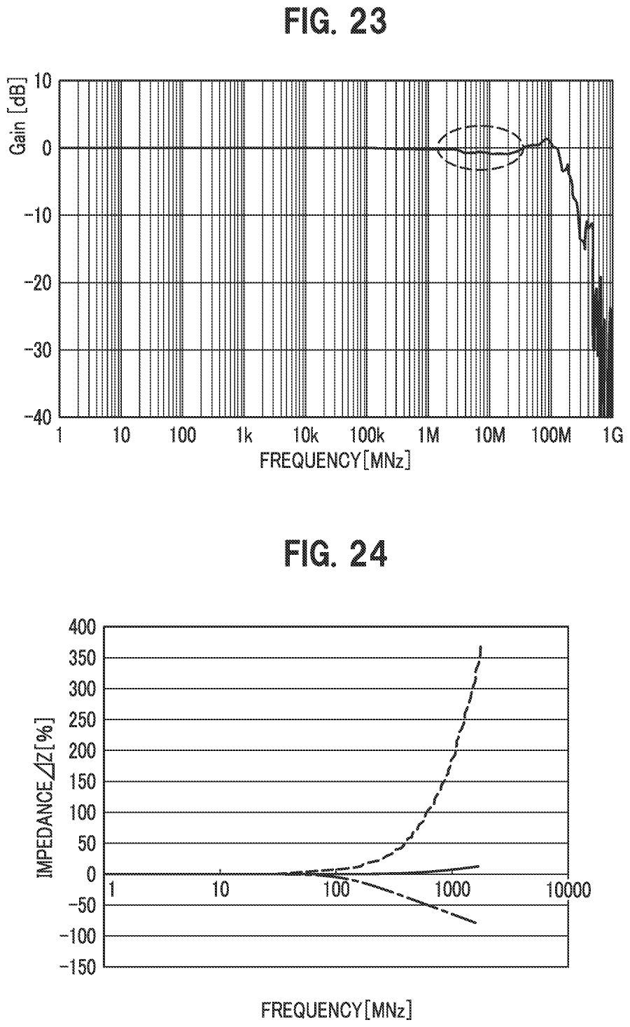

FIG. 23 is a diagram illustrating the frequency characteristics of the current probe 20.

The horizontal axis is frequency (Hz), and the vertical axis is gain (dB). The rated bandwidth of the current probe 20 is 120 MHz (−3 dB). The current probe 20 is characterized by having the following features: the gain is substantially zero at low frequencies not higher than 1 MHz; is lowered a little at frequencies of several to 30 MHz (broken line); and is returned at around 100 MHz.

This characteristic feature of the current probe 20 can explain the phenomenon in which the current ratio of measured current to calculated current (FIG. 19) exceeds 100% at frequencies of 2 to 30 MHz. Furthermore, the characteristic feature can explain the phenomenon in which the decrease in effective current (FIGS. 5 and 11) through the resistor 4 with increasing frequency is greater than the decrease in effective voltage (FIGS. 4 and 10).

The high-frequency power supplied to the resistor 4 is calculated as R×I² in the above description. Supplying the high-frequency power calculated by R×I×V to the resistor 4 does not cause a significant change in the tendency of temperature change. In other words, the effective voltage (FIG. 4) across the resistor 4 is also frequency-dependent. The finding that increasing kinetic energy of electrons increases the amount of heat generated by the resistor 4 at frequencies of 2 to 30 MHz cannot be denied by the frequency characteristics of the current probe 20.

FIG. 24 is a diagram illustrating frequency characteristics of a typical resistor.

The horizontal axis is frequency (MHz), and the vertical axis is impedance change ΔZ (%) from the impedance with direct current. The impedance change ΔZ (%) of the resistor 4 is large at frequencies not lower than 100 MHz. In other words, the impedance change ΔZ of the resistor 4 is negligible at 2 to 30 MHz, which are frequencies of the sine-waves outputted from the function generator 1.

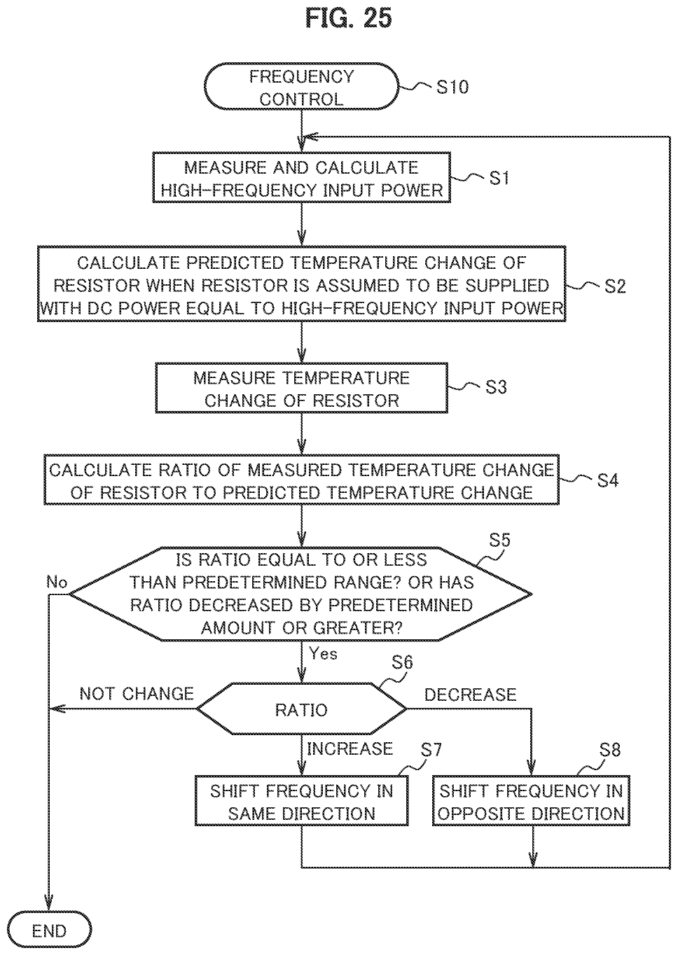

FIG. 25 is a flowchart for explaining the operation of the controller 50.

The steps of this process (S10) are sequentially executed by the controller 50 of the first and second embodiments.

The controller 50 first measures and calculates high-frequency input power to the resistor 4 (S1). In this step, the high frequency input power is a value obtained by multiplying the resistance R of the resistor 4 by the square of measured high-frequency current.

After processing of S1, the controller 50 acquires a predicted temperature change of the resistor 4 when the resistor 4 is assumed to be supplied with a DC power equal to the high-frequency input power, with reference to a table created based on the diagrams of FIGS. 6 and 12 (S2). After processing of S2, the controller 50 measures a temperature change of the resistor (S3). After processing in S3, the controller 50 calculates the ratio of the temperature change of the resistor 4 measured in S3 to the predicted temperature change acquired in S2 (S4). After processing of S4, the controller 50 determines whether the ratio calculated in S4 is equal to or less than a predetermined range or has decreased by a predetermined amount or greater (S5).

When the ratio calculated in S4 is equal to or less than the predetermined range or has decreased by the predetermined amount or greater (Yes in S5), the controller 50 determines whether the ratio calculated in S4 is greater (less) than a reference value or the previous value (S6). Herein, the controller 50 uses the reference value (an intermediate value of the predetermined range used in S5) the first time through the loop and uses the previous value the second or subsequent time through the loop.

After processing of S6, if the ratio calculated in S4 is greater than the reference or previous value (the ratio is determined to have increased in S6), the controller 50 shifts the frequency of the function generator 1 in the same direction (S7). That is, the frequency of the function generator 1 increases or decreases so as to increase the ratio to the maximum (See FIG. 8). If the ratio calculated in S4 is less than the reference or previous value (the ratio is determined to have decreased in S6), the controller 50 shifts the frequency of the function generator 1 (FIG. 1) in the opposite direction (S8). That is, the frequency of the function generator 1 increases or decreases so as to increase the ratio to the maximum (See FIG. 8). After processing in S7 or S8, the controller 50 returns the process to S1 and repeats the measurement and calculation of the high-frequency input power. When the ratio calculated in S4 is greater than the predetermined range or the ratio has not decreased by the predetermined amount or greater (No in S5) or when the ratio is equal to the reference or previous value (the ratio is determined not to have changed in S6), the controller 50 terminates this process.

Thus, the process (S10) shifts the frequency of the function generator 1 (FIG. 1) so as to maximize the ratio (quotient) of measured temperature change of the resistor 4 to predicted temperature change of the resistor 4 when the resistor 4 is assumed to be supplied with a DC power equal to the high-frequency input power supplied to the resistor 4 if the ratio is not greater than the predetermined range or has decreased by a predetermined amount or greater.

In other words, the controller 50 drives the function generator 1 (FIG. 1) at a frequency around such a frequency that maximizes the quotient obtained by dividing the amount of heat generated by the resistor 4, by the high-frequency input power supplied to the resistor 4.

What is claimed is:

1. A heat generator, comprising:
a high-frequency power source configured to generate a high-frequency power with a variable frequency;
a heating element connected to the high-frequency power source; and
a controller configured to set the high-frequency power to a frequency such that the high-frequency power with the frequency maximizes a quotient obtained by dividing a measured temperature change of the heating element by a temperature change of the heating element when the heating element is supplied with a DC power equal to the high-frequency power supplied to the heating element, the controller being configured to drive the high-frequency power source to generate the high-frequency power having approximately the frequency.

2. A heat generator, comprising:
a high-frequency power source configured to generate a high-frequency power with a variable frequency;
a heating element connected to the high-frequency power source; and
a controller configured to set the high-frequency power to a frequency such that the high-frequency power with the frequency maximizes a quotient obtained by dividing an amount of heat generated by the heating element by the high-frequency power supplied to the heating element, the controller being configured to drive the high-frequency power source to generate the high-frequency power having approximately the frequency.

3. The heat generator according to claim 2, wherein
the amount of heat is given by a measured temperature change of the heating element, and
the controller calculates the quotient by dividing the measured temperature change by a temperature change of the heating element when the heating element is supplied with a DC power equal to the high-frequency power supplied to the heating element.

4. The heat generator according to claim 1, wherein
the heating element includes a resistor, and
the quotient is maximized at the frequency of 2 to 30 MHz.

5. The heat generator according to claim 1, wherein
the controller shifts the frequency in response to the quotient which is less than a predetermined value.

6. The heat generator according to claim 1, wherein
the controller shifts the frequency in response to decrease of the quotient by a predetermined amount or greater.

7. A method of controlling a heat generator that is executed by a controller including:
a high-frequency power source configured to generate a high-frequency power with a variable frequency; and
a heating element connected to the high-frequency power source,
the method, executed by the controller, comprising:
setting the high-frequency power to a frequency by maximizing a quotient obtained by dividing a measured temperature change of the heating element by a temperature change of the heating element when the heating element is supplied with a DC power equal to the high-frequency power supplied to the heating element; and
driving the high-frequency power source by generating the high-frequency power having approximately the frequency.

8. The heat generator according to claim 2, wherein
the heating element includes a resistor, and
the quotient is maximized at the frequency of 2 to 30 MHz.

9. The heat generator according to claim 2, wherein
the controller shifts the frequency in response to the quotient which is less than a predetermined value.

10. The heat generator according to claim 2, wherein
the controller shifts the frequency in response to decrease of the quotient by a predetermined amount or greater.
